(19) United States
(12) Patent Application Publication
(10) Pub. No.: US 2019/0236549 A1
(43) Pub. Date: Aug. 1, 2019

(54) INTEGRATION AND OPTIMIZATION OF TIME CLOCK DATA FOR DISASTER RELIEF AND RECOVERY

(71) Applicant: GrammaPro, LLC, Jonesville, LA (US)

(72) Inventor: James D. Thornton, Jonesville, LA (US)

(21) Appl. No.: 15/881,094

(22) Filed: Jan. 26, 2018

(51) Int. Cl. G06Q 10/10

(52) U.S. Cl. CPC G06Q 10/105

(57) ABSTRACT

A computerized method includes receiving, at a report generating tool, an identification of a type of report to be generated based on user selection. The method further includes receiving an identification of a start date and an end date for the user selected type of report to be generated, the identification of the start date and the end date being identified based on user input, the start date and the end date defining a duration for the user selected type of report. The method further includes retrieving, by the report generating tool, a first portion of payroll data comprising one or more of the plurality of time entries from one or more databases and identifying, by the report generating tool, a second portion of payroll data corresponding to the user selected type of report in response to a user selection of the one or more time entries. The method further includes determining, by the report generating tool, a payroll reimbursement amount based on the second portion of data, the payroll reimbursement amount calculated based on the second portion of payroll data and a first reimbursement percentage, and generating, by the report generating tool, a report comprising the payroll reimbursement amount, wherein the report is submitted to a government agency for reimbursement of expenses related to a rebuild or repair of a structure.

### TECHNICAL FIELD

This disclosure relates in general to integrating and optimizing data, and more particularly, to integrating and optimizing time clock data for disaster relief and recovery.

### BACKGROUND

A number of government agencies provide government assistance to individuals and/or organizations for the repair or rebuild of structures damaged during a disaster such as hurricanes, fires, and flooding. In order to take advantage of this government assistance, the individuals and/or organizations must apply for financial assistance. Applications for financial assistance generally include a breakdown of expenses related to the repair or rebuild of structures damaged during a disaster. This breakdown is commonly prepared in a report format, the content of which is manually prepared by individuals and/or organizations. These reports are generally time consuming and onerous to put together as the information included in the report is manually collected, manually calculated, and manually input. Additionally, manually prepared reports are prone to user errors and deficiencies. For example, it may be difficult for the party preparing the report to determine a duration of use for a particular piece of equipment. This may be because the party preparing the report was not present at the time the equipment was used and/or was not involved at all with the repair or rebuild. In some cases, the party preparing the report may not include the unknown values and/or variables in the report, which in turn affects the total amount of financial assistance that the individual/organization may be eligible for.

### SUMMARY OF THE DISCLOSURE

According to one embodiment, a computerized method includes receiving, at a report generating tool, an identification of a type of report to be generated based on user selection. The method further includes receiving an identification of a start date and an end date for the user selected type of report to be generated, the identification of the start date and the end date being identified based on user input, the start date and the end date defining a duration for the user selected type of report. The method further includes retrieving, by the report generating tool, a first portion of payroll data comprising one or more of the plurality of time entries from one or more databases and identifying, by the report generating tool, a second portion of payroll data corresponding to the user selected type of report in response to a user selection of the one or more time entries. The method further includes determining, by the report generating tool, a payroll reimbursement amount based on the second portion of data, the payroll reimbursement amount calculated based on the second portion of payroll data and a first reimbursement percentage, and generating, by the report generating tool, a report comprising the payroll reimbursement amount, wherein the report is submitted to a government agency for reimbursement of expenses related to a rebuild or repair of a structure.

Certain embodiments may provide one or more technical advantages. For example, an embodiment of the present disclosure provides a system configured to integrate time clock data from a payroll application and optimize such data for disaster relief and recovery purposes. As another example, an embodiment of the present disclosure provides an efficient solution to generating data intensive reports that utilize time clock data. As yet another example, an embodiment of the present disclosure provides a computer with specialized functionality capable of correlating particular types of data to determine and or predict particular values and/or variables needed for a report. Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1A is a block diagram illustrating an example of a network environment for a report generating tool;

FIG. 1AB is a block diagram illustrating an example computer system that may be used to implement the method of FIG. 2, according to certain embodiments;

FIG. 2 is a flow chart illustrating a method of generating a report using the report generating tool of FIG. 1A, according to one embodiment;

FIG. 3 is an example of a user interface displayed by the report generating tool of FIG. 1A;

FIG. 4 is another example of a user interface displayed by the report generating tool of FIG. 1A;

FIG. 5 is another example of a user interface displayed by the report generating tool of FIG. 1A;

FIG. 6 is another example of a user interface displayed by the report generating tool of FIG. 1A;

FIG. 7 is another example of a user interface displayed by the report generating tool of FIG. 1A;

FIG. 8 is another example of a user interface displayed by the report generating tool of FIG. 1A;

FIG. 9 is an example of a report generated by the report generating tool of FIG. 1A, according to one embodiment.

### DETAILED DESCRIPTION OF THE DISCLOSURE

The devastation and destruction that can come with an earthquake, hurricane, fire, flood, tornado or other natural disaster can be staggering. Many people lose their homes, businesses, and belongings every year due to natural disasters. The aftermath of natural disasters may include the repair and/or rebuild of many structures, which may take many months and/or many years to complete. One hurdle that those affected by a natural disaster typically run into is applying for governmental financial assistance (e.g., Federal Emergency Management Agency (“FEMA”), United States Department of Agriculture (“USDA”)). These applications for assistance are typically formatted as reports and include expenses related to the rebuild and/or repair of a structure. Conventionally, these reports are manually prepared and, as a result, take a lot of time to prepare and may include mistakes and/or deficiencies. Mistakes and/or deficiencies in a report may cause the report to be denied and/or rejected, causing an already lengthy process to take additional time. In some instances, time is a luxury that persons affected by a natural disaster do not have. For example, most people begin the repair and/or rebuild of structures soon after a natural disaster so they can move forward with their life. As a result, those affected by a natural disaster may hire contractors and/or workers to begin the repair and/or rebuild, agreeing to pay the workers as soon as practical. Any unnecessary delays in payment may have unintended consequences on those affected by the natural disaster. As such, timing of completing the applications may be pivotal.

In addition to including actual expenses related to the repair and/or rebuild of a structure, the prepared reports values reflecting reimbursement eligible expenses. As used herein “reimbursement eligible expenses” or “reimbursement costs” refer to monetary amounts that an individual and/organization seeks reimbursement for from one or more government agencies. The teachings of this disclosure recognize integrating and optimizing payroll data (also referred to as “time clock data”) for disaster relief and recovery purposes. As an example, payroll data may be integrated and optimized to generate a disaster relief and recovery report. In some embodiments, the payroll data is integrated and optimized using a report generating tool. The following describes systems and methods of integrating and optimizing payroll data.

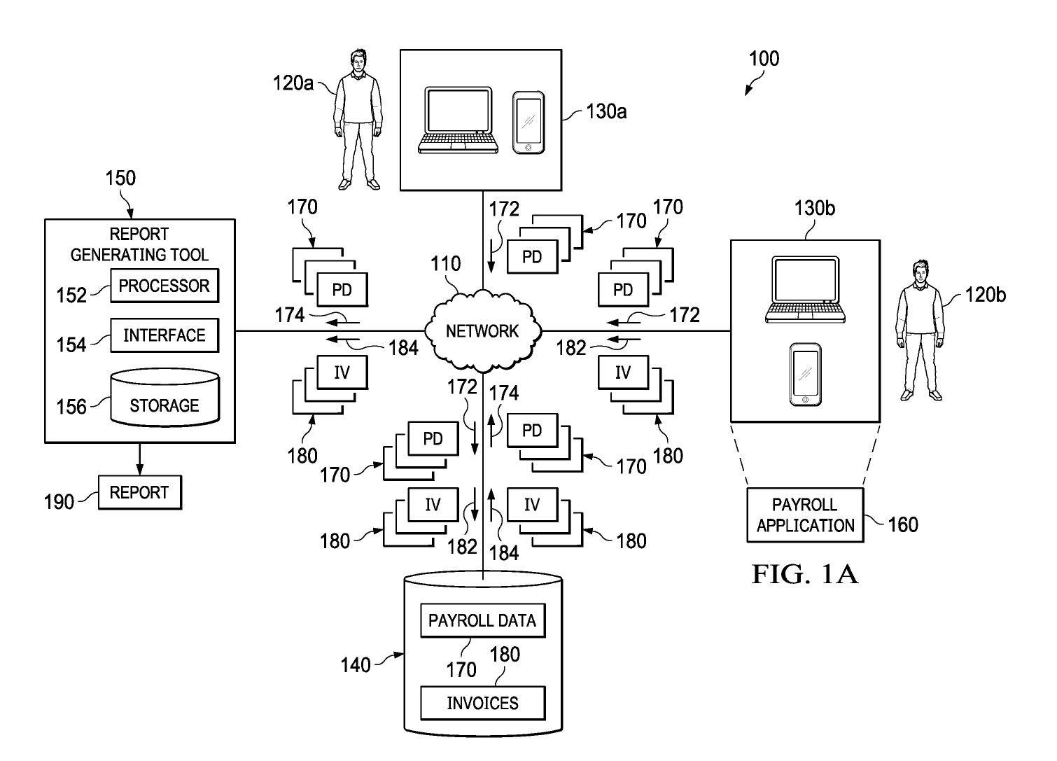

FIG. 1A illustrates a network environment for a report generating tool. The network environment 100 may include a network 110, one or more users 120, one or more user devices 130, one or more databases 140, and report generating tool 150. In general, the teachings of this disclosure recognize using report generating tool 150 to generate reports comprising payroll data 170. As indicated by arrows 172, user 120 may generate payroll data 170 by interacting with payroll application 160. Some or all of payroll data 160 may be stored to the one or more databases 140 and may be accessed by report generating tool 150 to generate report 190.

Network 110 may refer to any interconnecting system capable of transmitting audio, video, signals, data, messages, or any combination of the preceding. Network 110 may include all or a portion of a public switched telephone network, a public or private data network, a local area network (LAN), an ad hoc network, a personal area network (PAN), a metropolitan area network (MAN), a wide area network (WAN), a local, regional, or global communication or computer network such as the Internet, an enterprise intranet, or any other suitable communication link, including combinations thereof. One or more portions of one or more of these networks may be wired or wireless. Examples of wireless networks 110 may include a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these.

Network environment 100 may include one or more users 120. As depicted in FIG. 1A, network environment 100 includes two users 120a-b. Although this disclosure describes and depicts only two users, this disclosure recognizes that network environment 100 may include any suitable number of users 120. In some embodiments, users 120a-b may are administrators within organizations that are responsible for payroll.

User 120 may be associated with one or more user devices 130. As depicted in FIG. 1A, each user 120 is associated with two user devices 130. In some embodiments, user devices 130 are configured execute a payroll application or program (e.g., payroll application 160). As used herein, “payroll application” refers to payroll software configured to be executed on user device 130. Payroll application 160 may be configured to track time worked by each person associated with one or more organizations (e.g., an employee) and to process payment to each person associated with the one or more organizations commensurate with tracked time. In some embodiments, the data generated by payroll application 160 (referred to herein as “payroll data”) is based on entries or input from the employee themselves. For example, an employee may login to payroll application 160 with an assigned username and password and log times corresponding to time worked by that employee. As an example, payroll application 160 may log the exemplary information in TABLE 1:

TABLE 1

| User | | Clock | Lunch | Lunch | Clock | Work | |
|---|---|---|---|---|---|---|---|
| ID | Date | In | Out | In | Out | Time | Time Type |
| 00001 | Sep. 4, 2017 | 8:09 | 12:00 | 13:00 | 17:15 | 8.0 | Overtime |
| 00002 | Sep. 4, 2017 | 8:20 | 12:00 | 13:00 | 17:35 | 8.25 | Regular |
| 00030 | Sep. 4, 2017 | 8:04 | 12:07 | 13:03 | 17:10 | 8.25 | Regular |
| 00041 | Sep. 4, 2017 | 12:00 | | | 17:30 | 5.5 | Overtime |

According to TABLE 1 above, payroll application 160 received information about four employees: an employee associated with User ID 00001, an employee associated with User ID 00002, and an employee associated with User ID 00030, and an employee associated with User ID 00041. Based on the entries for User ID 0001, the employee associated with User ID 0001 began work on Sep. 4, 2017 at 8:09 a.m., took a lunch break on Sep. 4, 2017 between 12:00 p.m. and 1:00 p.m., and left work on Sep. 4, 2017 at 5:15 p.m. Based on the entries for User ID 00002, the employee associated with User ID 00002 began work on Sep. 4, 2017 at 8:20 a.m., took a lunch break on Sep. 4, 2017 between 12:00 p.m. and 1:00 p.m., and left work on Sep. 4, 2017 at 5:35 p.m. Based on the entries for User ID 00030, the employee associated with User ID 00030 began work on Sep. 4, 2017 at 8:04 a.m., took a lunch break on Sep. 4, 2017 between 12:07 p.m. and 1:03 p.m., and left work on Sep. 4, 2017 at 5:10 p.m. Based on the entries for User ID 00041, the employee associated with User ID 00041 began work on Sep. 4, 2017 at 12:00 p.m. and left work on Sep. 4, 2017 at 5:30 p.m.

In addition to time clock entries, TABLE 1 also shows a total number of hours worked based on the time clock entries and an identification of the time type for each entry. For example, TABLE 1 shows that the employee associated with User ID 0001 worked for a total of 8.0 hours on Sep. 4, 2017 and that these hours were overtime hours rather than regular time hours. In contrast, TABLE 1 shows that the employee associated with User ID 00002 worked for a total of 8.5 hours on Sep. 4, 2017 and that these hours were regular hours rather than regular time hours. In some instances, employees are paid at a different rate for overtime hours than regular hours. For example, an employee may be paid at 1.5 times regular pay for overtime hours. TABLE 2 below illustrates exemplary rates associated with User IDs 00001, 00002, 00030, and 00041:

TABLE 2

| | Regular Pay | Overtime Pay |
|---|---|---|
| User ID | Rate | Rate |
| 00001 | $10.00 | $15.00 |
| 00002 | $9.00 | $14.00 |
| 00030 | $8.00 | $13.00 |
| 00041 | $20.00 | $30.00 |

In some embodiments, payroll application 160 may identify overtime hours from regular hours based on a calculation of regular hours. For example, payroll application 160 may be programmed to determine that every minute and/or hour in excess of 40 hours is overtime. In such an example, payroll application 160 may calculate a total number of hours worked by an employee in a one week period and subtract forty (40) hours to determine the number of overtime hours worked by the employee.

In addition to receiving entries corresponding to time worked by personnel, payroll application 160 may also receive information from user 120. As an example, user 120 may input (manually or otherwise) information regarding personnel (e.g., pay rates, contact information, banking information, non-tax deductions, pre-tax deductions) and/or one or more organizations (e.g., Employer Identification Number). As another example, user 120 may update, modify, or delete information entered by personnel (e.g., incorrect entries) and/or add information that should have been entered by personnel (e.g., add a clock-out time entry for a time clock entry). As yet another example, user 120 may input and/or define various fields of payroll application 160 that may affect payroll (e.g., define particular days as holidays associated with a holiday pay rate, defining pay periods/cycles). Although this disclosure has described particular ways in which user 120 may interact with payroll application 160, this disclosure recognizes that user 120 may interact with payroll application 160 in any suitable way.

Payroll application 160 may also be configured to receive information over a network such as network 110. As an example, payroll application 160 may receive updates via network 110 related to current and/or future tax information (e.g., rate for Social Security tax, rate for Medicare tax). Using some or all of the information received, payroll application 160 may perform the necessary calculations to generate paystubs corresponding to payments made to the personnel of an organization. Generally, payments are made to personnel of an organization at the end of each pay cycle, which may be, for example, every two weeks.

This disclosure recognizes storing a portion of the data received by payroll application 160 (illustrated in FIG. 1A as payroll data 170) in one or more databases 140. As such, this disclosure recognizes that user devices 130 may be communicably coupled to the one or more databases 140. Although network environment 100 is illustrated as including only a single database 140, this disclosure recognizes that network environment 100 may include any suitable number of databases 140 configured to store data received by payroll applications 160 executed on user devices 130.

In some embodiments, user device 130 sends only a portion of the data 170 received by payroll application 160 for storage in database 140. In other embodiments, user device 130 sends all data 170 received by payroll application 160 to database 140 for storing. In such an embodiment, network environment 100 may also include a filtering tool configured to filter payroll data 170 received by payroll application 160 to identify information to store as payroll data 170. In some embodiments, report generating tool 150 employs the filtering functionality. For example, all data from payroll application 160 may be sent to report generating tool 150 to identify a portion of data to be archived, and once identified, report generating tool 150 may facilitate the storing of the identified portion of data in the one or more databases 140. In some embodiments, the stored portion of payroll data 140 includes at least a user identifier (e.g., an employee ID name or number), time(s) and date(s) associated with the user identifier indicating time worked by an employee or other personnel, a time type indicator (e.g., regular time, overtime), and pay rates associated with each user identifier.

Payroll data 170 may, in some embodiments, be stored (also referred to herein as “archived”) in database 140 following each pay cycle of an organization. In other embodiments, payroll data 170 is archived at a different rate (e.g., annually, quarterly). In yet other embodiments, payroll data 170 is archived at some other time desirable to user 120 and/or operator of report generating tool 150.

The one or more databases 140 may also be configured to store other types of information. As an example, databases 140 may also be configured to store invoices 180. As used herein, invoices 180 may be or include an itemized bill for goods sold or services provided. In some embodiments, invoices may be associated with a repair or rebuild of one or more structures. For example, an organization may employ the services of a general contractor in connection with the rebuild of a house that was damaged by a natural disaster such as a hurricane. As another example, an organization may rent or buy certain equipment or materials in connection with the rebuild of the house. In both examples, a service provider (e.g., a contractor) or goods provider (e.g., equipment rental facility, hardware store) may provide an invoice to the organization for payment purposes.

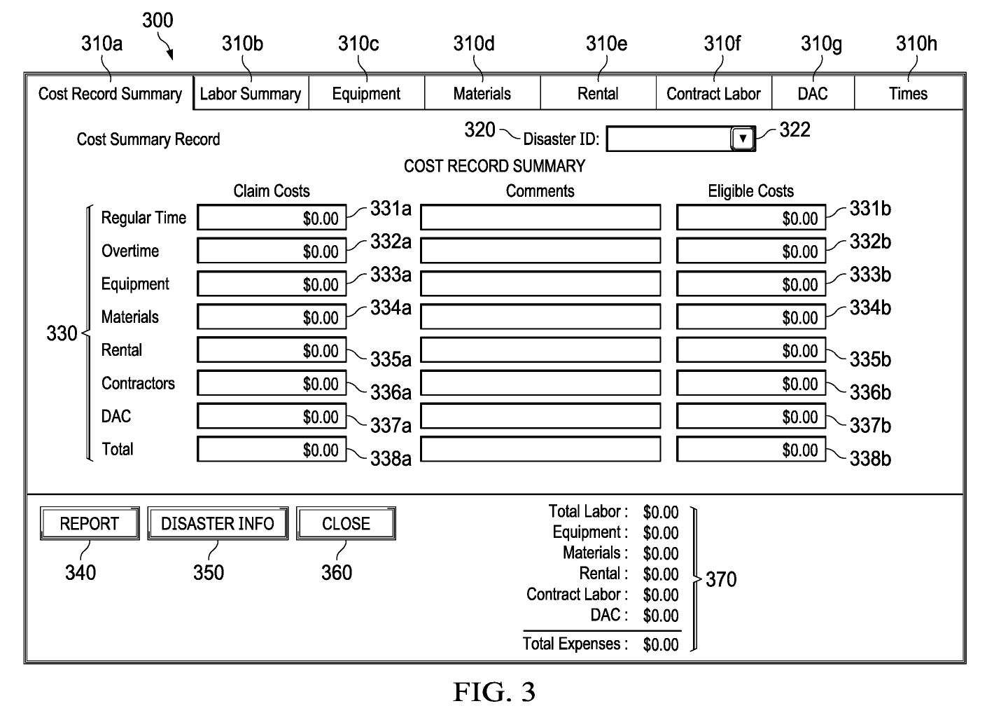

As indicated by arrows 182, user 120 may upload invoices 180 to database(s) 140 for use by report generating tool 150. For example, as illustrated in FIG. 1A, user 120b uploads invoices 180 through network 110 for storage at database 140. In some embodiments, the contents of invoices 180 may be text searchable (e.g., optical character recognition is performed on invoices 180). In other embodiments, invoices 180 may be uploaded to database 140 along with particular identifying information. For example, user 120b may be prompted to specify one or more of a date associated with the invoice (e.g., date of invoice, date of services rendered, date of goods sold), a name of invoice provider (e.g., name of company and/or person providing the invoice), or an identifier of a disaster (e.g., Hurricane Harvey, Tri-State Tornado, Winter Storm Nemo) before invoice 180 may be stored in database 140. As will be explained in more detail below in reference to FIGS. 3-8, these types of identifying data may be used by report generating tool 150.

Finally, network environment 100 may include report generating tool 150. In some embodiments, such as depicted in FIG. 1A, report generating tool 150 may be a specialized computer comprising hardware such as a processor 152, an interface 154, and storage 156. In other embodiments, report generating tool 150 may be software configured to be executed on a processor of a computer such as computer 191 of FIG. 1B. In such an embodiment, report generating tool 150 may use the memory and processing power of computer 191 to execute some or all logic disclosed herein. In yet other embodiments, report generating tool 150 may be a combination of software and hardware. This disclosure recognizes that the software may be hardware-specific (e.g., software may be specifically written for a Windows, Android, and/or iOS device).

Processor 152 of report generating tool 150 may be operable to execute code stored to storage 156. Such code may be operable, when executed by processor 152, to perform one or more functions of report generating tool 150 disclosed herein. As an example, the code may be operable when executed to identify a portion of payroll data 170 to store in database 140. As another example, the code may be operable when executed to generate a report comprising some or all of payroll data 170. In some embodiments, storage 156 of report generating tool 150 stores other data in addition to executable code. For example, storage 156 may store one or more reports generated by report generating tool 150. As another example, storage 156 may store schedules, templates of reports, and/or values required by such templates (e.g., standard reimbursement percentages, FEMA's Schedule of Equipment Rates). As yet another example, storage 156 may store pay rate information (see e.g., pay rate information included in TABLE 2) associated with each employee identifier. Although this disclosure identifies particular types of data stored in storage 156, this disclosure recognizes that storage 156 may store any desirable data.

As described above, report generating tool 150 also may include interface 154. Interface 154 is operable to communicate with elements in network environment 100. As an example, interface 154 may communicate with database 140. As another example, interface 154 may communicate with user devices 130 and/or with a user-controlled mouse and/or keyboard. Descriptions of interactions with report generating tool 150 will be described in more detail below.

Report generating tool 150 may be operable to generate report 190. The report may be one or more of a quarterly report, a payroll history report, a pay history report, a federal deposit history report, an unemployment report, a worker's compensation report, a payroll reimbursement report, and/or a fringe benefit report. Any of these such reports may comprise and/or utilize payroll data 170. The report generated by report generating tool 150 may be based on user input, payroll data 170, and/or invoices 180. As described above, payroll data 170 may originate from one or more payroll applications executed on user devices 130 and user devices 130 may also facilitate the storage of invoices 180 in database 140. Generally, report generating tool 150 receives user input, retrieves a portion of payroll data 170 from database 140 based on user input (indicated by arrows 174), calculates a payroll reimbursement amount based on a user-identified selection of the retrieved portion of payroll data and a reimbursement percentage, and generates report 190 comprising the calculated payroll reimbursement amount.

As will be described in more detail below, report generating tool 150 may be further operable to calculate other reimbursement values for other categories such as a materials reimbursement amount, a rental reimbursement amount, a contract labor reimbursement amount, and an administrative reimbursement amount. The generated report 190 may comprise some or all of the calculated reimbursement amounts and may additionally comprise a total reimbursement amount that is, in some embodiments, the sum of the payroll reimbursement amount, the materials reimbursement amount, the rental reimbursement amount, the contract labor reimbursement amount, and the administrative reimbursement amount. One or more of the above-listed reimbursement amounts may be based at least in part by information in invoices 180. In such case, report generating tool may retrieve, from database 140, one or more invoices 180 (as indicated by arrows 184), and use the information of retrieved invoices 180 to calculate a reimbursement amount.

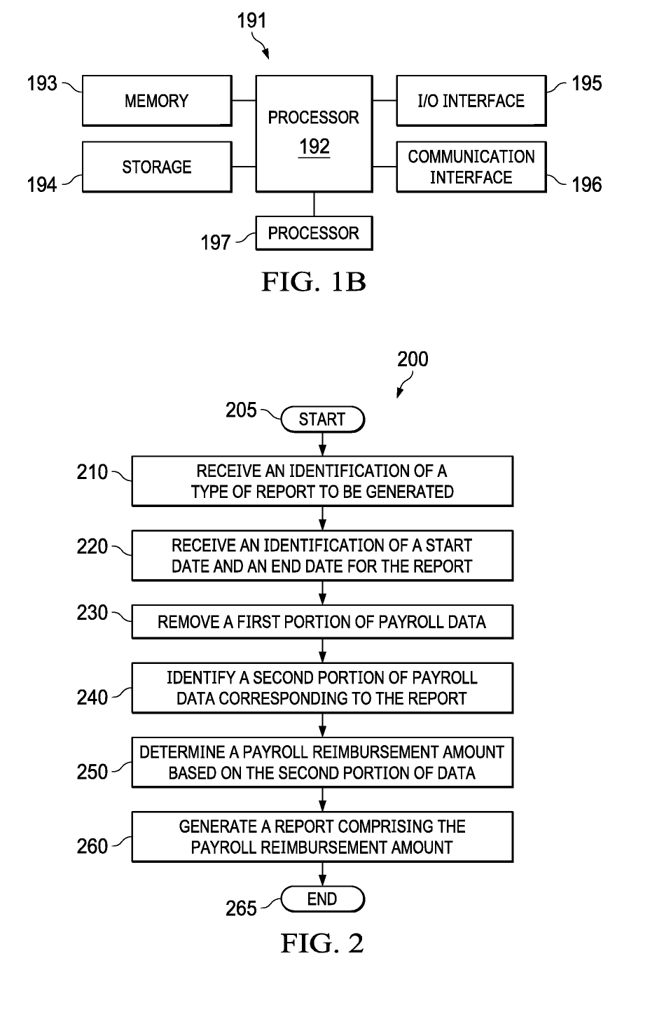

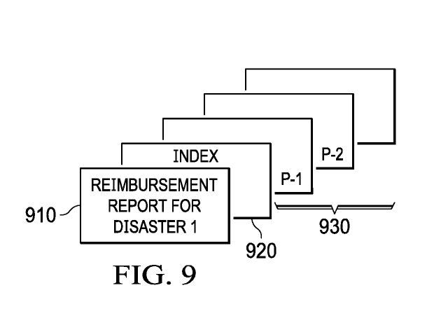

As explained above, FIG. 1A illustrates network environment 100 for report generating tool 150 and further illustrates that report generating tool 150 is operable to receive payroll data 170 and/or invoices 180 and generate a report 190 from the received payroll data 170 and/or invoices 180. FIG. 1B illustrates a computer system 191 operable to run report generating tool 150. FIG. 2 illustrates a method of generating a report using reporting generating tool 150 and FIGS. 3-8 illustrates examples of interfaces presented by report generating tool 150. FIG. 9 illustrates an example of a report 190 generated by report generating tool 150.

FIG. 1B illustrates an example of a computer system 191. As described above, report generating tool 150 may be a program that is implemented by a processor of a computer system such as computer system 191. Computer system 191 may be any suitable computing system in any suitable physical form. In some embodiments, computer system 191 may be device 130. As example and not by way of limitation, computer system 191 may be a virtual machine (VM), an embedded computer system, a system-on-chip (SOC), a single-board computer system (SBC) (e.g., a computer-on-module (COM) or system-on-module (SOM)), a desktop computer system, a laptop or notebook computer system, a mainframe, a mesh of computer systems, a server, an application server, or a combination of two or more of these. Where appropriate, computer system 191 may include one or more computer systems 191; be unitary or distributed; span multiple locations; span multiple machines; or reside in a cloud, which may include one or more cloud components in one or more networks. Where appropriate, one or more computer systems 191 may perform without substantial spatial or temporal limitation one or more steps of one or more methods described or illustrated herein. As an example and not by way of limitation, one or more computer systems 191 may perform in real time or in batch mode one or more steps of one or more methods described or illustrated herein. One or more computer systems 191 may perform at different times or at different locations one or more steps of one or more methods described or illustrated herein, where appropriate. Some or all of the steps of the methods described herein may be performed automatically. Additionally, this disclosure describes various functionalities of report generating tool 150 that may be performed automatically. This disclosure recognizes that the automatic performance of such steps and/or functionalities may be associated with benefits such as a reduction in CPU resources, memory resources, and network bandwidth that would otherwise be required to perform these actions.

One or more computer systems 191, including user device 130, may perform one or more steps of one or more methods described or illustrated herein. As described above, user device 130 or another computer system 191 may perform all or some of the steps of the methods described herein (e.g., method 200 of FIG. 2). In particular embodiments, one or more computer systems 191 provide functionality described or illustrated herein. In particular embodiments, software running on one or more computer systems 191 performs one or more steps of one or more methods described or illustrated herein or provides functionality described or illustrated herein. Particular embodiments include one or more portions of one or more computer systems 191. Herein, reference to a computer system may encompass a computing device, and vice versa, where appropriate. Moreover, reference to a computer system may encompass one or more computer systems, where appropriate.

This disclosure contemplates any suitable number of computer systems 191. This disclosure contemplates computer system 191 taking any suitable physical form. As an example and not by way of limitation, computer system 191 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 191 may include one or more computer systems 191; be unitary or distributed; span multiple locations; span multiple machines; span multiple data centers; or reside in a cloud, which may include one or more cloud components in one or more networks. Where appropriate, one or more computer systems 191 may perform without substantial spatial or temporal limitation one or more steps of one or more methods described or illustrated herein. As an example and not by way of limitation, one or more computer systems 191 may perform in real time or in batch mode one or more steps of one or more methods described or illustrated herein. One or more computer systems 191 may perform at different times or at different locations one or more steps of one or more methods described or illustrated herein, where appropriate.

Computer system 191 may include a processor 192, memory 193, storage 194, an input/output (I/O) interface 195, a communication interface 196, and a bus 197 in some embodiments, such as depicted in FIG. 1B. Although this disclosure describes and illustrates a particular computer system having a particular number of particular components in a particular arrangement, this disclosure contemplates any suitable computer system having any suitable number of any suitable components in any suitable arrangement.

Processor 192 includes hardware for executing instructions, such as those making up a computer program, in particular embodiments. For example, processor 192 may execute report generating tool 150 to generate one or more reports 190. As an example and not by way of limitation, to execute instructions, processor 192 may retrieve (or fetch) the instructions from an internal register, an internal cache, memory 193, or storage 194; decode and execute them; and then write one or more results to an internal register, an internal cache, memory 193, or storage 194. In particular embodiments, processor 192 may include one or more internal caches for data, instructions, or addresses. This disclosure contemplates processor 192 including any suitable number of any suitable internal caches, where appropriate. As an example and not by way of limitation, processor 192 may include one or more instruction caches, one or more data caches, and one or more translation lookaside buffers (TLBs). Instructions in the instruction caches may be copies of instructions in memory 193 or storage 194, and the instruction caches may speed up retrieval of those instructions by processor 192. Data in the data caches may be copies of data in memory 193 or storage 194 for instructions executing at processor 192 to operate on; the results of previous instructions executed at processor 192 for access by subsequent instructions executing at processor 192 or for writing to memory 193 or storage 194; or other suitable data. The data caches may speed up read or write operations by processor 192. The TLBs may speed up virtual-address translation for processor 192. In particular embodiments, processor 192 may include one or more internal registers for data, instructions, or addresses. This disclosure contemplates processor 192 including any suitable number of any suitable internal registers, where appropriate. Where appropriate, processor 192 may include one or more arithmetic logic units (ALUs); be a multi-core processor; or include one or more processors. Although this disclosure describes and illustrates a particular processor, this disclosure contemplates any suitable processor.

Memory 193 may include main memory for storing instructions for processor 192 to execute or data for processor 192 to operate on. As an example and not by way of limitation, computer system 191 may load instructions from storage 194 or another source (such as, for example, another computer system 191) to memory 193. Processor 192 may then load the instructions from memory 193 to an internal register or internal cache. To execute the instructions, processor 192 may retrieve the instructions from the internal register or internal cache and decode them. During or after execution of the instructions, processor 192 may write one or more results (which may be intermediate or final results) to the internal register or internal cache. Processor 192 may then write one or more of those results to memory 193. In particular embodiments, processor 192 executes only instructions in one or more internal registers or internal caches or in memory 193 (as opposed to storage 194 or elsewhere) and operates only on data in one or more internal registers or internal caches or in memory 193 (as opposed to storage 194 or elsewhere). One or more memory buses (which may each include an address bus and a data bus) may couple processor 192 to memory 193. Bus 197 may include one or more memory buses, as described below. In particular embodiments, one or more memory management units (MMUs) reside between processor 192 and memory 193 and facilitate accesses to memory 193 requested by processor 192. In particular embodiments, memory 193 includes random access memory (RAM). This RAM may be volatile memory. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 193 may include one or more memories 180, where appropriate. Although this disclosure describes and illustrates particular memory, this disclosure contemplates any suitable memory.

Storage 194 may include mass storage for data or instructions. As an example and not by way of limitation, storage 194 may include a hard disk drive (HDD), a floppy disk drive, flash memory, an optical disc, a magneto-optical disc, magnetic tape, or a Universal Serial Bus (USB) drive or a combination of two or more of these. Storage 194 may include removable or non-removable (or fixed) media, where appropriate. Storage 194 may be internal or external to computer system 191, where appropriate. In particular embodiments, storage 194 is non-volatile, solid-state memory. In particular embodiments, storage 194 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 194 taking any suitable physical form. Storage 194 may include one or more storage control units facilitating communication between processor 192 and storage 194, where appropriate. Where appropriate, storage 194 may include one or more storages 140. Although this disclosure describes and illustrates particular storage, this disclosure contemplates any suitable storage.

I/O interface 195 may include hardware, software, or both, providing one or more interfaces for communication between computer system 191 and one or more I/O devices. Computer system 191 may include one or more of these I/O devices, where appropriate. One or more of these I/O devices may enable communication between a person and computer system 191. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 185 for them. Where appropriate, I/O interface 195 may include one or more device or software drivers enabling processor 192 to drive one or more of these I/O devices. I/O interface 195 may include one or more I/O interfaces 185, where appropriate. Although this disclosure describes and illustrates a particular I/O interface, this disclosure contemplates any suitable I/O interface.

Communication interface 196 may include hardware, software, or both providing one or more interfaces for communication (such as, for example, packet-based communication) between computer system 191 and one or more other computer systems 191 or one or more networks (e.g., network 110). As an example and not by way of limitation, communication interface 196 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 196 for it. As an example and not by way of limitation, computer system 191 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 191 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 191 may include any suitable communication interface 196 for any of these networks, where appropriate. Communication interface 196 may include one or more communication interfaces 190, where appropriate. Although this disclosure describes and illustrates a particular communication interface, this disclosure contemplates any suitable communication interface.

Bus 197 may include hardware, software, or both coupling components of computer system 191 to each other. As an example and not by way of limitation, bus 197 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 197 may include one or more buses 197, where appropriate. Although this disclosure describes and illustrates a particular bus, this disclosure contemplates any suitable bus or interconnect.

The components of computer system 191 may be integrated or separated. In some embodiments, components of computer system 191 may each be housed within a single chassis. The operations of computer system 191 may be performed by more, fewer, or other components. Additionally, operations of computer system 191 may be performed using any suitable logic that may comprise software, hardware, other logic, or any suitable combination of the preceding.

Turning now to FIG. 2, FIG. 2 illustrates a method 200 of generating a report (e.g., report 190). Some or all of the steps of method 200 may be performed by report generating tool 150, which as stated above, may be a specialized computer such as computer 191 of FIG. 1B. Method 200 may be an algorithm stored to storage 156 of report generating tool 150 and may be executable by processor 152 of report generating tool 150. The method 200 may begin in a step 205 and continue to a step 210. At step 210, report generating tool 150 receives an identification of a type of report to be generated based on a user selection. For example, user 120c (not illustrated), an administer of report generating tool 150, may select (e.g., from a drop down menu) an option to create a reimbursement report. Although the above example describes user 120c selecting a particular report option, other options may be presented and selected by user 120c. For example, user 120c may select an option to create one or more of a quarterly report, a payroll history report, a pay history report, a federal deposit history report, an unemployment report, a worker's compensation report, and/or a fringe benefit report. In some embodiments, the component of report generating tool 150 that receives the identification of the type of report to be generated is interface 154. After receiving the indication of the type of report to be generated, the method 200 may continue to a step 220.

At step 220, report generating tool 150 receives an identification of a start date and an end date for the user selected type of report to be generated. The start date and the end date may define a duration for the user selected type of report. In some embodiments, the component of report generating tool 150 that receives the identifications of the start and end dates is interface 154. The start and end dates may be indicated via input from a user (e.g., user 120c). As an example, user 120c may type (e.g., via keyboard) in a first date and a second date, the first date corresponding to a start date and the second date corresponding to the end date. As another example, user 120c may select a date for each of the start and the end dates by clicking on a particular date in a pop-up calendar. In some embodiments, the method 200 continues to a step 230 after receiving identifications of start and end dates.

At step 230, report generating tool 150 retrieves a first portion of payroll data. The first portion of payroll data may, in some embodiments, be retrieved from one or more databases 140 in network environment 100. As explained above, the one or more databases 140 may be configured to store payroll data 170. In some embodiments, the retrieved first portion of payroll data comprises one or more time entries corresponding to dates between the user identified start date and end date. For example, if at step 220, report generating tool 150 received a user selection of a start date of Sep. 3, 2017 and an end date of Sep. 5, 2017, then report generating tool 150 may retrieve all of the time entries included in TABLE 1 above. In some embodiments, the retrieved first portion of payroll data also comprises pay rates associated with employees (e.g., the information included in TABLE 2). In some embodiments, the method 200 continues to a step 240 after retrieving the first portion of payroll data.

At step 240, report generating tool 150 identifies a second portion of payroll data. The second portion of payroll data may include some or all of the time entries retrieved at step 230. In some embodiments, the second portion of payroll data is identified based on user selection. For example, user 120c may select one or more time entries of the time entries retrieved at step 230 as an indication that the selected time entries are associated with the report to be generated (e.g., report 190). After identifying the second portion of payroll data, the method 200 may continue to a step 250.

At step 250, report generating tool 150 determines a payroll reimbursement amount based on the second portion of payroll data and a first reimbursement percentage. In some embodiments, report generating tool 150 calculates the reimbursement amount based on the second portion of payroll data, pay rates associated with each employee identified within the second portion of payroll data, and a first reimbursement percentage. For example, report generating tool 150 may calculate, for each time type (e.g., regular and overtime), a total number of hours worked for each employee based on the second portion of data. Report generating tool 150 may then determine, for each employee, a payroll cost for each type of time worked for each employee. This calculation may be performed by summing together the number of regular hours worked by each employee between the start date and the end date and separately summing together the number of overtime hours worked by each employee between the start date and the end date. These sums are then multiplied by pay rates (e.g., either regular rate or overtime rate) for the respective employee to generate a payroll cost for each employee. The payroll cost associated with each employee may then be summed together to generate a total payroll cost. The total payroll cost is then multiplied by a reimbursement percentage to generate the payroll reimbursement amount. As will be further explained below, the reimbursement percentage may be manually input and/or automatically populated by user 120 and/or report generating tool 150. As is also disclosed in more detail below, the reimbursement percentage may be modified via user input. In some embodiments, the method 200 continues to a step 260 after determining the payroll reimbursement amount.

At step 260, report generating tool 150 generates report 190 comprising the payroll reimbursement amount determined at step 250. In some embodiments, the report generated at step 260 is submitted to a government agency (e.g., FEMA, USDA, HAZMAT) to request reimbursement of expenses related to the rebuild or repair of one or more structures. In some embodiments, the method 200 continues to an end step 265 after generating report 190.

As explained above, FIGS. 3-8 illustrate examples of interfaces presented by report generating tool 150. FIG. 3 illustrates interface 300, which in some embodiments, may be a home page presented by report generating tool 150. In some instances, report generating tool 150 may present interface 300 only after a user (e.g., user 120c) has successfully been authorized to use report generating tool 150. Authorization may be desirable due to the confidential nature of payroll data 170. Interface 300 may include one or more tabs 310 presenting different types of information. For example, as illustrated in FIG. 3, cost record summary tab 310a displays a cost record summary for a particular disaster. To populate data for a particular disaster, user 120c may select a previously saved disaster ID 320 from a drop down menu 322. For example, user 120c may select “DISASTER 1” (not illustrated) from drop down menu 322. In response to selecting “DISASTER 1” from drop down menu 322, report generating tool 150 may populate one or more calculated variables in sections 330 and/or 370 of interface 300.

As illustrated in FIG. 3, section 300 includes three columns of information: claim costs, comments, and eligible costs. As described herein, claim costs may refer to the actual cost of a particular expense (e.g., regular payroll costs, overtime payroll costs, equipment costs, materials costs, rental costs, contractor costs, direct administrative costs (DAC)) and eligible costs may refer to the costs that are eligible for reimbursement. As illustrated, interface 300 illustrates $0.00 values in each box in sections 330 and 370 because no Disaster ID has been selected. If “DISASTER 1” was selected from drop down menu 322 of interface 300, one or more of the boxes in sections 330 and/or 370 may populate values other than $0.00. For example, if user 120c had previously stored labor data corresponding to “DISASTER 1,” report generating tool 150 may populate values in regular time claim costs box 331a, overtime claim costs box 332a, total claim costs box 338 regular time eligible costs box 331b, overtime eligible costs box 332b, and total eligible costs box 338b. In such an example, report generating tool 150 may also populate values in section 370 (e.g., value corresponding to “Total Labor”). If user 120c had also previously stored other data (e.g., cost information related to equipment, materials, rental, contract labor, and DAC related to “DISASTER 1,” report generating tool 150 may also populate other values in sections 330 and/or 370. For example, report generating tool 150 may also populate values for other claim cost boxes (e.g., equipment claim costs box 333a, materials claim costs box 334a, rental claim costs box 335a, contractor claim costs box 336a, and DAC claim costs box 337a) and eligible costs boxes (e.g., equipment eligible costs box 333b, materials eligible costs box 334b, rental eligible costs box 335b, contractor eligible costs box 336b, and DAC eligible costs box 337b) and/or corresponding values in section 370.

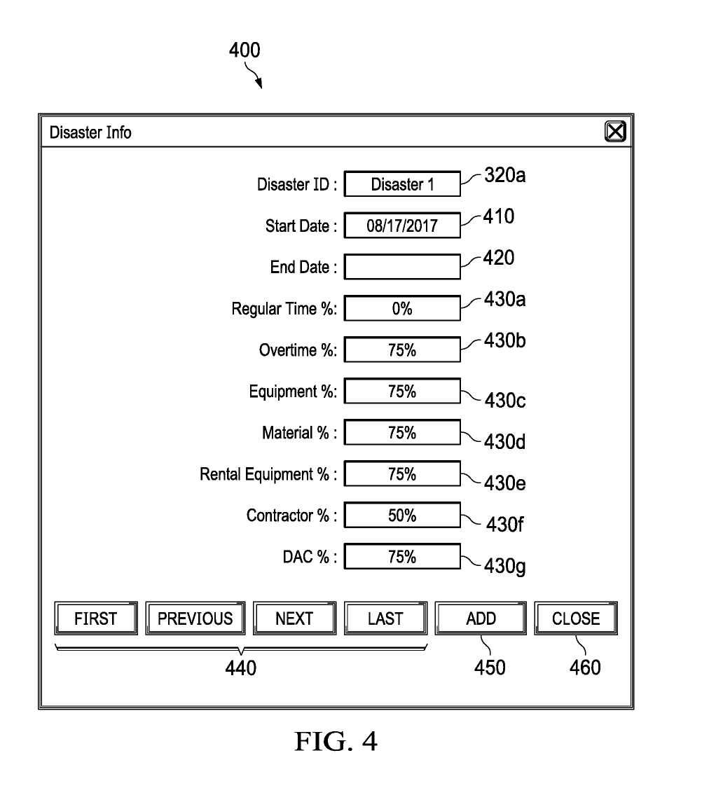

Interface 300 also includes three user selectable buttons: a “Report” button 340, a “Disaster Info” button 350, and a “Close” button 360. In some embodiments, these user-selectable buttons are displayed in some or all interfaces of report generating tool 150. For example, buttons 340, 350, and 360 are present in each of the interfaces illustrated in FIGS. 4-8. In response to receiving a user selection of “report” button 340, report generating tool 150 may generate a report (e.g., report 190) associated with the disaster ID 320 displayed in drop down menu 322. In response to receiving a user selection of “close” button 360, a computer (e.g., computer 191 of FIG. 1B) may stop executing instructions for report generating tool 150. Upon user selection of “disaster info” button 350, report generating tool 150 may present another interface (e.g., interface 400 of FIG. 4).

FIG. 4 illustrates an example interface 400 of report generating tool 150. In some embodiments, interface 400 is displayed in response to a user selection of “disaster info” button 350 of interface 300. In some instances, a user may select “disaster info” button 350 in order to generate a report for a new disaster. As illustrated, interface 400 includes a plurality of user-fillable boxes (e.g., 320a, 410, 420, 430a-g) and navigation buttons (e.g., 440, 450, and 460). Interface 400 may be operable to receive input from user 120 for one or more of the user-fillable boxes. For example, as illustrated in FIG. 4, user 120 has provided the following input: “Disaster 1” is the disaster ID 320a, the start date 410 for “Disaster 1” is Aug. 17, 2017, 0% is the regular time reimbursement percentage 430a, 75% is the overtime reimbursement percentage 430b, 75% is the equipment reimbursement percentage 430c, 75% is the material reimbursement percentage 430d, 75% is the rental equipment reimbursement percentage 430e, 50% is the contractor reimbursement percentage 430f, and 75% is the direct administrative costs reimbursement percentage 430e.

As illustrated in FIG. 4, user 120 may not define values/criteria for one or more user-fillable boxes of interface 400. In such cases, report generating tool 150 may auto-populate values/criteria. For example, report generating tool 150 may auto-populate the current date as end date 420 when an end date 420 has not been defined by user 120. As another example, report generating tool 150 may auto-populate a value (e.g., 75%) as the reimbursement percentage for each of the user-fillable reimbursement percentages 430. In some embodiments, user may select “add” button 450 after inputting information for one or more user-fillable boxes of interface 400. In such case, report generating tool 150 may display a workspace tailored to the user-defined criteria input in interface 400. For example, report generating tool 150 may display an interface similar to interface 300 but populating “Disaster 1” in drop down menu 322. User 120 may then associate information with the “Disaster 1” disaster ID 320a such that data for each tab 310 is updated based on user input and/or selections, and in some cases, data stored to database(s) 140.

Although this disclosure describes setting up a workspace for a particular disaster ID (“Disaster 1” 320a), this disclosure recognizes that user 120 may create any suitable number of workspaces to accommodate one or more disasters. For example, user 120 may input information in user-fillable boxes in interface 400 for another disaster (e.g., “Disaster 2”) and store this information by clicking “add” button 450. As such, user 120 may create disaster IDs 320 for any number of disasters. Once created, however, it may be desirable to edit, change, or update information related to one of the user-created disaster IDs 320. In such case, user 120 may use navigation buttons 440 to find a desired disaster ID 320 and manipulate the information displayed in interface 400 as desired (e.g., to change a reimbursement percentage 430, to edit start date 410 and/or end date 420). For example, report generating tool 150 may present an interface similar to interface 400 but displaying user-fillable information for a “Disaster A” in response to user selection of the “FIRST” button. As another example, report generating tool 150 may present an interface similar to interface 400 but displaying user-fillable information for a “Disaster Z” in response to user selection of the “PREVIOUS” button. As yet another example, report generating tool 150 may present an interface similar to interface 400 but displaying user-fillable information for a “Disaster 2” in response to user selection of the “NEXT” button. As yet another example, report generating tool 150 may present an interface similar to interface 400 but displaying user-fillable information for a “Disaster 100” in response to user selection of the “LAST” button. User 120 may close interface 400 at any time by clicking “CLOSE” button 460 of interface 400.

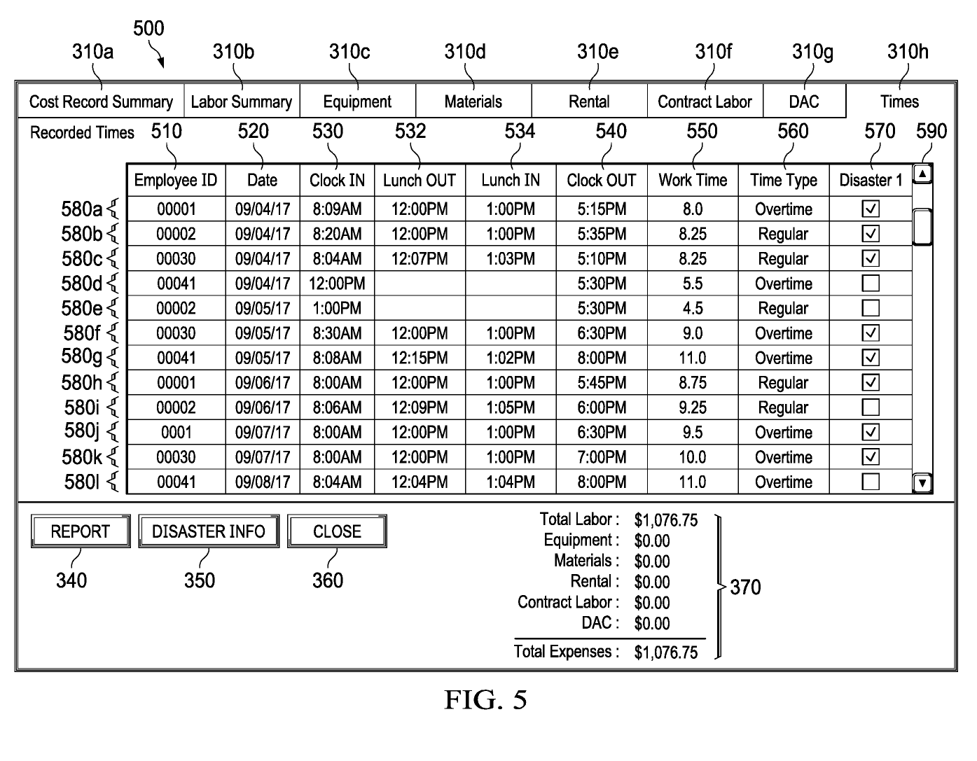

FIG. 5 illustrates an example interface 500 showing time tab 310h populated based on information provided by user 120 in interface 400. As explained above in reference to FIG. 2, report generating tool 150 receives an identification of start date 410 and end date 420 associated with a particular disaster ID 320 (e.g., “Disaster 1” 320a) and retrieves corresponding payroll data. For example, in response to user 120 selecting “add” button 450 of interface 400, report generating tool 150 may query database(s) 140 for payroll data comprising time entries occurring between start date 410 (e.g., Aug. 17, 2017) and end date 420 (e.g., current date). As illustrated in FIG. 5, the retrieved time entries 580a-1 are displayed within time tab 310h and each retrieved time entry 580 is associated with a particular date 520, a particular employee identifier (ID) 510, a total work time 550 which may, in some cases be determined based on time punches (e.g., clock in time 530, lunch out time 532, lunch in time 534, and clock out time 440), and a time type 560 (e.g., regular or overtime).

Report generating tool 150 is configured to receive a user selection of one or more of the retrieved entries 580 on interface 500. For example, as illustrated in FIG. 5, user 120 selected time entries 580a, 580b, 580c, 580f, 580g, 580h, 580j, and 580k. In some embodiments, user 120 selects time entries 580 based on whether the time entries are related to a particular disaster. For example, user 120 may select time entries 580a, 580b, 580c, 580f, 580g, 580h, 580j, and 580k because the labor was performed in connection with Disaster 1. As another example, user 120 may not select time entries 580d, 580e, 580i, and 580l because the labor was not performed in connection with Disaster 1.

In response to user selection of one or more time entries 580 on interface 500, report generating tool 150 may calculate total payroll expenses incurred based on the data included in each selected time entry 580 and pay rate information (e.g., regular pay rate and overtime pay rate) associated with each implicated employee ID 510. An example algorithm for calculating payroll expenses may be: (1) determine, for each employee ID 510, a total number of regular hours worked based on data included in the user-selected time entries 580; (2) determine, for each employee ID 510, a total number of overtime hours worked based on data included in the user-selected time entries 580; (3) identify an employee ID 510 associated with each user-selected time entry; (4) retrieve, from storage 156 and/or database(s) 140, a regular pay rate and an overtime pay rate associated with each identified employee ID 510; (5) determine, for each identified employee ID 510, an overtime payroll cost by multiplying the total number of overtime hours worked by that employee's respective overtime pay rate; (6) determine, for each identified employee ID 510, a regular payroll cost by multiplying the total number of regular hours worked by that employee's respective regular pay rate; (7) sum together all of the overtime payroll costs and regular payroll costs for a total labor cost.

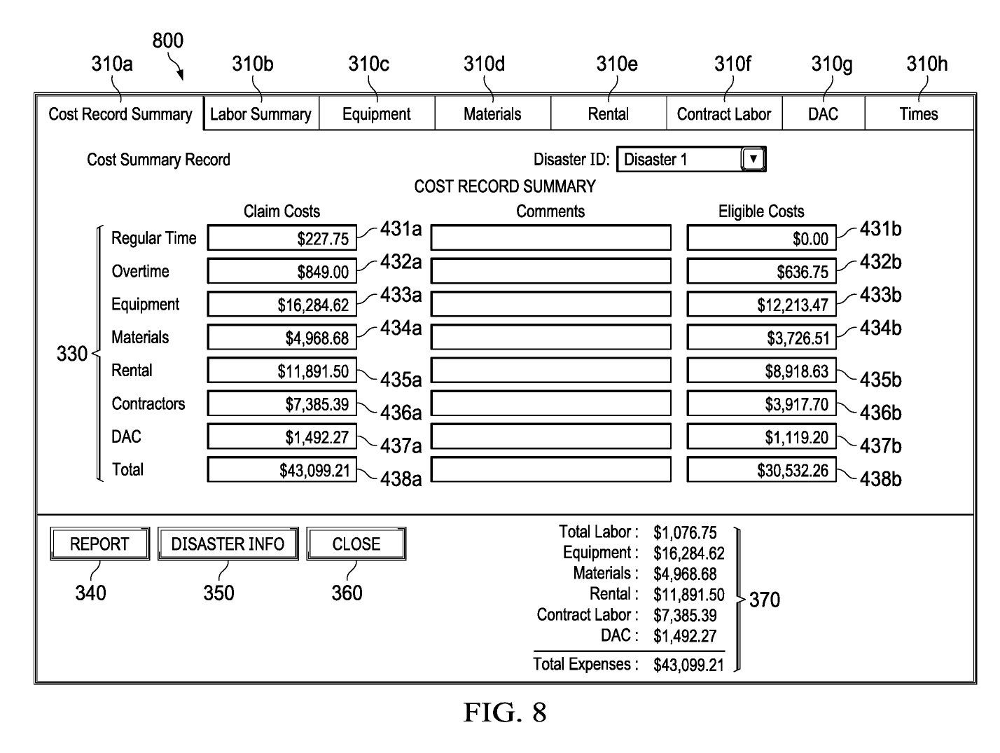

After calculating total labor expenses for the user-selected time entries 580, report generating tool 150 may update section 370 of interface 500 to reflect the total labor cost. In some embodiments, report generating tool 150 updates one or more other tabs 310 in response to the user-selected time entries 580. For example, as will be explained in further detail with respect to FIG. 8, report generating tool 150 may update regular time claim costs box 431a and overtime claim costs box 432b of cost record summary tab 310a. As another example, report generating tool 150 may update labor summary tab 310b to include the user-selected time entries 580 from interface 500.

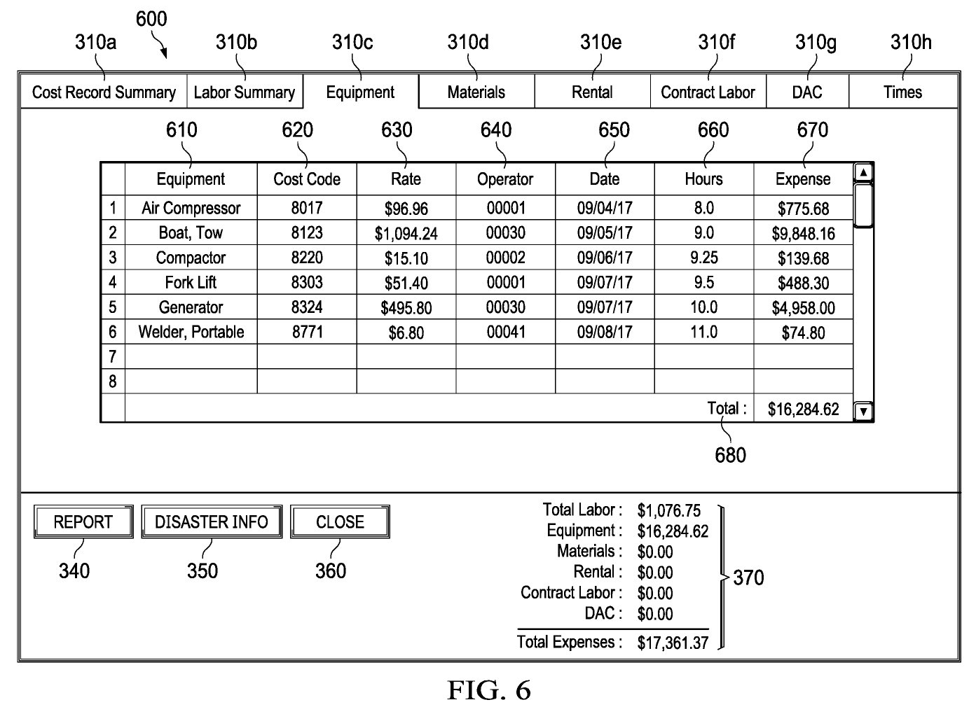

FIG. 6 illustrates an example interface 600 showing equipment tab 210c for Disaster 1. This disclosure recognizes that some government agencies reimburse organizations and/or individuals for the use of equipment utilized in the repair or rebuild of structures. As such, it may be desirable to determine eligible equipment costs. In some embodiments, equipment tab 210c may include the data used to calculate such costs.

As illustrated in FIG. 6, interface 600 includes an itemized listing of all equipment used in the repair or rebuild of one or more structures damaged during Disaster 1. As illustrated in the equipment column 610 of FIG. 6, six pieces of equipment 610 were used during the repair or rebuild of one or more structures that were damaged by Disaster 1. Each piece of equipment may be associated with a cost code 620. In some embodiments, the cost code 620 is determined by a government agency. For example, cost codes 620 may be cost codes included in FEMA's Schedule of Equipment Rates. Each cost code 620 may be correspond to a particular equipment reimbursement rate 630. In some embodiments, equipment reimbursement rates 630 are also determined by a government agency.

As described above, use of equipment in the rebuild or repair of one or more structures may be a reimbursable expense. Thus, report generating tool 150 may be operable to calculate actual equipment costs and/or reimbursable equipment costs. In one embodiment, report generating tool 150 calculates the equipment cost of a single piece of equipment by multiplying the rate associated with the piece of equipment by the duration of use of the piece of equipment. To calculate the total equipment expense, report generating tool 150 may sum together each calculated equipment expense (e.g., all values in expense column 610). Taking FIG. 6 as an example, report generating tool 150 calculates the equipment expense for each piece of equipment in equipment column 610 by multiplying its associated rate (e.g., specified in rate column 630) and duration used (e.g., specified in hours column 660), and presents the calculated equipment expense in expense column 670. Report generating tool 150 may then sum together each calculated equipment expense in expense column 670 to determine a total equipment expense (e.g., $16,284.62).

This disclosure recognizes that user 120 and/or report generating tool 150 may populate values in column 610, 620, 630, 640, 650, 660, and 670. Additionally, this disclosure recognizes that user 120 may edit and/or delete line items included in the itemized listing of interface 600. As an example, user 120 may input (e.g., by typing and/or selecting option from a drop down menu) an identification of equipment used during the repair or rebuild of structures damaged during Disaster 1 in the equipment column 610 of interface 600. In some embodiments, user 120 manually enters corresponding cost code 620 and reimbursement rate 630 associated with the equipment identified in equipment column 610. In some other embodiments, report generating tool 150 auto-populates cost code 620 and reimbursement rate 630 for each line item in response to receiving an identification of equipment 610 in the equipment column 610 of interface 600. For example, in response to user 120 inputting “Air Compressor” in line 1 of interface 600, report generating tool 150 may populate one or more cost codes 620 associated with the equipment term “air compressor.” An algorithm for such functionality may be or include: (1) receive, by report generating tool 150, an identification of a type of equipment as a line item on interface 600; (2) retrieve, from memory 156, one or more cost codes 620 associated with the identification; (3) present, by report generating tool 150, the one or more cost codes 620 associated with the identification; (4) receive, by report generating tool 150, a selection of the one or more presented cost codes 620; (5) query memory 156 for a reimbursement rate 630 associated with the selected cost code 620; (6) auto-populate the line item with both the selected cost code 620 and the reimbursement rate 630 associated with the selected cost code 620.

Report generating tool 150 may also determine durations of use for each user-identified piece of equipment. In one embodiment, report generating tool 150 may determine such durations of equipment use based on information manually input by user 120. In another embodiment, report generating tool 150 determines durations of equipment use based on one or more of payroll data, date of equipment use, and/or certifications of employees. As an example, user 120 may manually input a date of equipment use (e.g., Sep. 4, 2017) in date of column 650. In response to manually inputting a date, report generating tool 150 may (1) identify, from user-selected entries 580 of interface 500, one or more time entries 580 associated with the inputted date; (2) select one of the one or more time entries 580 associated with the inputted date; and (3) auto-populate the operator column 640 and the hours column 660 with values that correspond to the selected time entry 580. For example, in response to user 120 inputting Sep. 4, 2017, report generating tool 150 may identify entries 580a-d, select one entry (e.g., entry 580a), and auto-populate the operator column 640 with 00001 (corresponding to employee ID 00001) and auto-populate the hours column 660 with 8.0, the number of hours corresponding to employee ID 0001's Sep. 4, 2017 time entries. Preference to select one entry 580 over other user-selected time entries 580 may be based on one or more factors such as (1) ordering of the time entries (e.g., time entry 580a occurs before time entries 580b-d); and (2) a certification of an employee to operate particular equipment. Identifications of such certifications may be stored, for example, in storage 156. Although this disclosure describes certain factors that may influence a selection of report generating tool 150 to choose one time entry 580 over another, this disclosure recognizes that report generating tool 150 may select one time entry 580 over another for any suitable reason. Auto-population by report generating tool 150 may also occur in a corresponding reverse manner. For example, user 120 may manually input an employee ID in operator column 640 and report generating tool 150 may auto-populate values in the date column 650 and hours column 660. Selection of such auto-populated values may be based, in some embodiments, on the ordering of the time entries.

In another embodiment, report generating tool 150 generates user-selectable options of values rather than values themselves. For example, in response to user 120 inputting a date, report generating tool 150 may present a pop-up window including all user-selected entries 580 that include the date input by user 120 (e.g., time entries 580a-d). In such example, user 120 may select the time entry 580 for the employee ID that operated the equipment at issue. As another example, report generating tool 150 may present a pop-up window including all user-selected entries 580 that include employee ID 00001 in response to user 120 manually inputting “00001” in operator column 640. In response to user-selection of a particular time entry 580 within the pop-up window, report generating tool 150 may auto-populate date column 650 and hours column 660 with the respective date and time of the selected entry.

In some embodiments, report generating tool 150 may update section 370 of interface 600 to reflect the total equipment expense. In some embodiments, report generating tool 150 updates one or more other tabs 310 in response to calculating the total equipment expense. For example, as will be explained in further detail with respect to FIG. 8, report generating tool 150 update cost record summary tab 310a to reflect the total equipment expense in equipment claim costs box 333a.

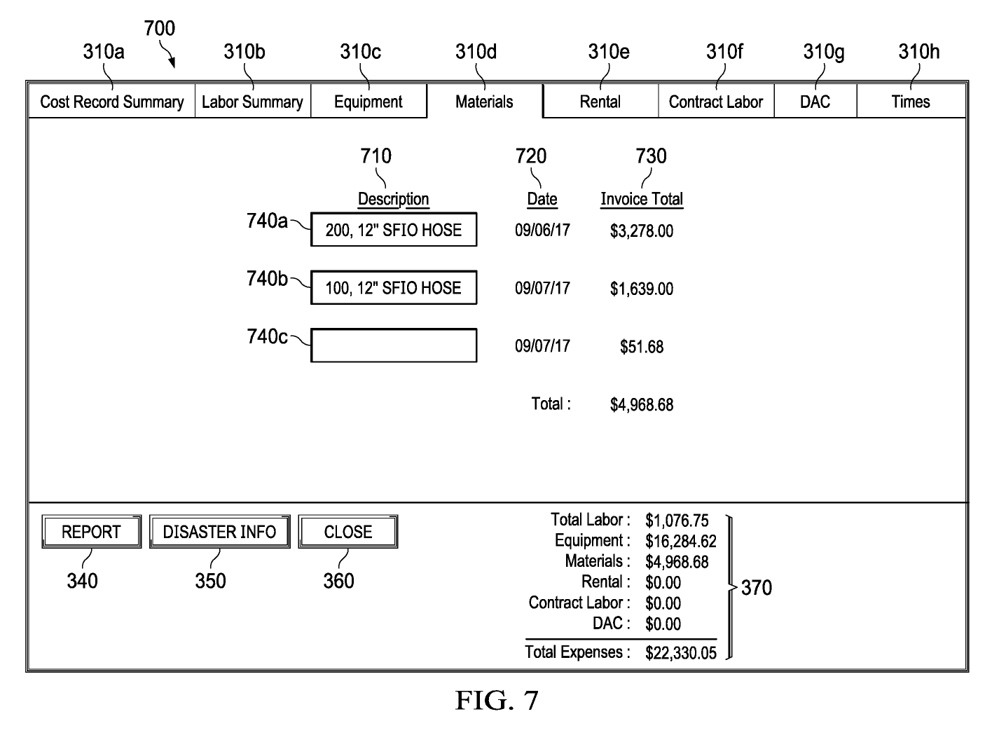

FIG. 7 illustrates an example interface 700 showing materials tab 310d for Disaster 1. Materials tab 310d may present information regarding materials expenses related to Disaster 1. In some embodiments, user 120 manually inputs each materials expense. In doing so, user 120 may input a description of the material purchased 710, a date 720 associated with such purchase, and a cost 730 associated with the material(s) purchased. In other embodiments, report generating tool 150 populates line items in materials tab 310d based on received invoices 170. In such an embodiment, report generating tool 150 may query database(s) 140 for invoices 170 for a particular disaster. As an example, this may be performed by searching database(s) 140 for invoices 170 that include a date between start date 410 and end date 420. As another example, this may be performed by searching database(s) 140 for invoices that include a particular identifier (e.g., searching by disaster ID 320).

As illustrated in FIG. 7, materials tab 310d populated three line entries 740 based on invoices 170. User 120 may edit, delete, or update some or all of the text auto-populated by report generating tool 150. For example, as illustrated in FIG. 7, user 120 deleted the description of materials in line item 740c. As another example, user 120 may edit line entry 740a to reflect a second material included in the Sep. 6, 2018 invoice of $3,278.00

In some embodiments, report generating tool 150 calculates a total materials expense by summing together each line item total in the invoice total column 730. As illustrated in FIG. 7, report generating tool 150 calculated the total materials expense for Disaster 1 as $4,968.68 based on the line items invoice totals in column 730. Report generating tool 150 may also update section 370 of interface 700 to reflect the total materials expense. In some embodiments, report generating tool 150 updates one or more other tabs 310 in response to calculating the total materials expense. For example, as will be explained in further detail with respect to FIG. 8, report generating tool 150 updates cost record summary tab 310a to reflect the total materials expense in materials claim costs box 334a.

Although not depicted, this disclosure recognizes that other expenses may be calculated in a manner similar to that described above in regards to the materials expenses. For example, user 120 may manually populate one or more of rental tab 310e, contract labor tab 310f, and DAC tab 310g with line items to reflect costs associated with rental equipment, contract labor, and administrative costs, respectively. As another example, report generating tool 150 may auto-populate one or more of rental tab 310e, contract labor tab 310f, and DAC tab 310g with line items to reflect costs associated with rental equipment, contract labor, and administrative costs, respectively. Auto-population of such costs may be performed in a manner similar to that described above in regards to materials tab 310d. After populating line items, report generating tool 150 may calculate, based on total invoice costs included on each tab 310, one or more of a total rental expense, total contract labor expense, and total DAC expense and update section 370 and/or one or more other tabs 310 with the calculated expense totals.

FIG. 8 illustrates an example interface 800 showing an updated cost record summary tab 310a for Disaster 1 showing the effects of populating tabs 310b-h with data. As illustrated in FIG. 8, claim costs boxes (e.g., 431a, 432a, 433a, 434a, 435a, 436a, and 437a) have been updated to reflect the total calculated expenses for each category: regular time labor expense, overtime labor expense, equipment expense, materials expense, rental expense, contract labor expense, and DAC expenses. As explained above, report generating tool 150 may pull each of these calculated values from their respective tabs 310b-g. In some embodiments, report generating tool 150 is further operable to calculate a total claim cost, which in some embodiments, is the sum of all values in claim cost boxes 431a, 432a, 433a, 434a, 435a, 436a, and 437a. As illustrated in FIG. 8, the total claim cost for Disaster 1 is $43,099.21 (see total claim cost box 438a). In some embodiments, report generating tool 150 may update section 370 of interface 800 to reflect the total expense for Disaster 1.

In addition to actual expenses, interface 800 may also display reimbursement eligible expenses. As explained above, reimbursement eligible expenses may be calculated by category (e.g., regular time labor, overtime labor, equipment expenses, materials expenses, rental expenses, contractor expenses, DAC expenses) as the product of a reimbursement percentage and a claim cost. In some embodiments, the reimbursement percentage is the same for each category (e.g., 75%). In other embodiments, the reimbursement is not the same for each category (e.g., regular time reimbursement percentage is 0% and overtime reimbursement percentage is 75%). Report generating tool 150 may calculate reimbursement eligible expenses by multiplying an actual category expense by a reimbursement percentage. For example, equipment eligible expense 433b may be calculated by multiplying the value in equipment claim cost box 433a (e.g., $16,284.62) by equipment reimbursement percentage 430c. In such example, equipment eligible expense 433b is calculated as $12,213.47 as reflected in interface 800.

As illustrated and described in reference to FIG. 4, user 120 and/or report generating tool 150 may specify reimbursement percentages for each category. These specified reimbursement percentages may be used in the calculation of reimbursement eligible expenses. In some embodiments, report generating tool 150 calculates eligible expenses by category. For example, FIG. 4 illustrates that user 120 specified a regular time reimbursement percentage of 0%. Accordingly, report generating tool 150 calculates the eligible expense for regular time labor (e.g., $227.75*0.00=$0.00) as reflected in regular time eligible costs box 431b of FIG. 8. As another example, report generating tool 150 calculates the eligible expense for overtime labor as 75% of the amount in overtime claim costs box 432a based on overtime reimbursement percentage 430b in FIG. 4.

In addition to calculating reimbursement eligible costs by category, report generating tool 150 may further be operable to calculate and display a total for reimbursement eligible costs (see total eligible costs box 438b). In some embodiments, the total of reimbursement eligible costs is calculated as the sum of all categories of reimbursement eligible expenses. For example, report generating tool 150 may calculate total of reimbursement eligible expenses 438b by summing together the amounts in the eligible costs boxes (e.g., 431b, 432b, 433b, 434b, 435b, 436b, and 437b). As depicted in FIG. 8, the total of reimbursement eligible costs is $30,532.26.

Report generating tool 150 may further be configured to generate a report (e.g., report 190) comprising data from one or more tabs 310. As an example, the generated report 190 may comprise data included on cost record summary tab 310a of interface 800. Notably, this information would include actual claim costs (431a, 432a, 433a, 434a, 435a, 436a and 437a) and reimbursement eligible costs (431b, 432b, 433b, 434b, 435b, 436b, and 437b) and further include a total for reimbursement eligible costs (see total eligible costs box 438b). As another example, the generated report 190 may comprise data included on each tab 310 (e.g., data described and/or depicted above in reference to tabs 310b, 310c, 310d, 310e, 310f, 310g). As yet another example, the generated report 190 may comprise data included on a subset of tabs 310 (e.g., in a scenario wherein no data is input and/or populated in tab 310). In some embodiments, report 190 is generated by user selection of the report button 340 of interface 800.

FIG. 9 illustrates an example of a report 900 generated by report generating tool 150. As described above, a report generated by report generating tool 150 may include data from one or more tabs 310. Additionally, report generating tool 150 may be configured to create a cover page for generated report 900, illustrated in FIG. 9 as cover page 910. Cover page 910 may include a title for generated report 900 and, in some embodiments, include disaster ID 320. In some embodiments, report generating tool 150 may also include an index page 920 in generated report 900. Index page 920 may include a heading and an identification of page numbers corresponding to that heading. As used herein, a heading may refer to a short description of information displayed on particular pages. As an example, index page 920 may include the following information:

Cost Record Summary . . . 1-2

Labor Summary . . . 3-7

Equipment Summary . . . 8-9

Materials Summary . . . 10

Rental Summary . . . 11-12

Contract Labor Summary . . . 13

Direct Administrative Costs Summary . . . 14

In some embodiments, report generating tool 150 is further operable to apply one or more page numbers 930 to generated report 900. The page numbers applied by report generating tool 150 may correspond to one or more page numbers included on index page 920. In some embodiments, report 900 may also include one or more invoices used by report generating tool 150 is generating report 900.

Although this disclosure describes determining reimbursements for tangible damage (e.g., repair or rebuild of one or more structures), this disclosure also recognizes calculating reimbursements for intangible damage. As used herein, “intangible damages” may include

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Although this disclosure focuses on the example of generating a reimbursement report, this disclosure recognizes that other reports may be generated using report generating tool 150. For example, report generating tool 150 may be configured to generate one or more of a quarterly report, a payroll history report, a pay history report, a federal deposit history report, an unemployment report, a worker's compensation report, a payroll reimbursement report, and/or a fringe benefit report. Each of these types of reports may include payroll data. One or more of the methods described herein may be used to generate such reports.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the embodiments described or illustrated herein that a person having ordinary skill in the art would comprehend. The scope of this disclosure is not limited to the embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system comprising:
one or more databases storing a first portion of payroll data, the payroll data corresponding to one or more payroll cycles and received from one or more payroll systems, the first portion of the received payroll data comprising a pay rate for one or more employees and a plurality of time entries corresponding to the one or more employees, each time entry comprising at least a start time and an end time;
a processor; and
a memory configured to store instructions, the instructions when executed by the processor are operable to:
receive, based on user selection, an identification of a type of report to be generated, the type of report being one of the set comprising:
a quarterly report;
a payroll history report;
a pay history report;
a federal deposit history report;
an unemployment report;
a worker's compensation report;
a payroll reimbursement report;
a fringe benefit report;
receive, based on user selection, an identification of a start date and an end date for the user selected type of report to be generated, the start date and the end date defining a duration for the user selected type of report;
receive, based on user input, an identifier for the user selected type of report based on user input;
retrieve, from the one or more databases, a second portion of payroll data comprising one or more pay rates for each of one or more employees and a plurality of time entries, each time entry corresponding to a particular employee and occurring between the start date and the end date, each time entry comprising at least a start time and an end time;
in response to a user selection of one or more of the plurality of time entries, identify a third portion of payroll data corresponding to the user selected type of report, the third portion of payroll data being either the same as, or a subset of, the second portion of payroll data;
determine a payroll reimbursement amount calculated based on the third portion of payroll data and a first reimbursement percentage, wherein the payroll reimbursement amount is calculated by:
identifying, for each selected time entry, an employee corresponding to the entry;
determining, based on each time entry, whether the time entry corresponds to regular time or overtime;
determining, for each identified employee, an overtime pay amount, the overtime pay amount calculated based on an overtime pay rate and time entries determined to correspond to overtime;
in response to calculating overtime pay amount for each identified employee, calculate a total overtime amount, the total overtime amount comprising the sum of the overtime pay amounts for each identified employee;
multiplying the total overtime amount by the first reimbursement percentage; and
determine, based on user input, a cost code corresponding to an equipment used between the start date and the end date;
in response to user input identifying a time entry associated with the equipment, determine a number of hours that the equipment was operated;
calculate an equipment reimbursement amount based on the cost code, the number of hours that the equipment was operated, and a second reimbursement percentage;
calculate, based on user input and a third reimbursement percentage, a materials reimbursement amount, a rental reimbursement amount, a contract labor reimbursement amount, and an administrative reimbursement amount;
calculate a reimbursement total comprising the payroll reimbursement amount, the equipment reimbursement amount, the materials reimbursement amount, the rental reimbursement amount, the contract labor reimbursement amount, and the administrative reimbursement amount; and
generate a report comprising the reimbursement total, wherein the report is submitted to a government agency for reimbursement of expenses related to a rebuild or repair of at least one structure.

2. The system of claim 1, wherein the instructions, when executed by the processor, are further operable to:
in response to user input indicating a reimbursement percentage for regular time, re-calculate the payroll reimbursement amount based on the total overtime pay amount, a total regular pay amount, the first reimbursement percentage, and the reimbursement percentage for regular time, the total regular pay amount being the sum of regular pay amounts for each identified employee; and
generating a report comprising the recalculated payroll reimbursement amount.

3. The system of claim 1, wherein the instructions, when executed by the processor, are further operable to:
retrieve, in response to querying the one or more databases for invoices corresponding to search criteria comprising one or more of a date between the start date and end date or a name for the user selected type of report, a plurality of invoices corresponding to the search criteria; and
receive, based on user input, an identification of one or more of the plurality of invoices, wherein the identified invoices are included in the generated report.

4. The system of claim 3, wherein the instructions, when executed by the processor, are further operable to:
in response to identifying one or more of a total invoice amount, an invoice number, or an invoice date on at least one of the identified invoices, automatically populate one or more fields of a contract labor tab, a materials tab, a rentals tab, or an equipment tab with one or more of the total invoice amount, the invoice number; or the invoice date, wherein one or more of the total invoice amount, the invoice number; or the invoice date are identified based on contents of each identified invoice.

5. The system of claim 1, wherein the instructions, when executed by the processor, are further operable to:
number each page of the generated report; and
add an index page to the generated report.

6. The system of claim 1, wherein the government agency is one or more of the set comprising:
Federal Emergency Management Agency (FEMA); and
United States Department of Agriculture (USDA).

7. The system of claim 1, wherein the first reimbursement percent, the second reimbursement percent, and the third reimbursement percent are the same.

8. The system of claim 1, wherein the first reimbursement percent and the second reimbursement percent are different.

9. A computerized method comprising:
receiving, at a report generating tool, an identification of a type of report to be generated based on a user selection;
receiving, at the report generating tool, an identification of a start date and an end date for the user selected type of report to be generated, the identification of the start date and the end date being identified based on user input, the start date and the end date defining a duration for the user selected type of report;
retrieving, by the report generating tool, a first portion of payroll data comprising one or more of the plurality of time entries from one or more databases associated with the report generating tool, the one or more time entries occurring between the start date and the end date;
in response to a user selection of the one or more time entries, identifying, by the report generating tool, a second portion of payroll data corresponding to the user selected type of report, the second portion of payroll data being either the same as or a subset of the first portion of payroll data;
determining, by the report generating tool, a payroll reimbursement amount based on the second portion of data, the payroll reimbursement amount calculated based on the second portion of payroll data, pay rates associated with each employee identified within the second portion of payroll data, and a first reimbursement percentage;
generating, by the report generating tool, a report comprising the payroll reimbursement amount, wherein the report is submitted to a government agency for reimbursement of expenses related to a rebuild or repair of at least one structure.

10. The method of claim 9, wherein the method further comprises:
automatically determining, by the report generating tool, that the first reimbursement percentage is 75%; and
changing, based on user input, the first reimbursement percentage to a number that is not 75%.

11. The method of claim 9, further comprising:
determining, by the report generating tool, a cost code corresponding to an equipment used between the start date and the end date based on user input;
identifying, by the report generating tool, one or more of the selected time entries as being associated with the equipment, wherein the selected time entries are identified based on user input;
determining, by the report generating tool, a number of hours that the equipment was operated based on the identified time entries; and
calculating, by the report generating tool, an equipment reimbursement amount based on the cost code, the number of hours that the equipment was operated, and a second reimbursement percentage.

12. The method of claim 9, further comprising:
calculating, by the report generating tool, one or more other reimbursements amounts based on user input and one or more reimbursement percentages, the one or more reimbursement amounts being one or more of:
a materials reimbursement amount;
a rental reimbursement amount;
a contract labor reimbursement amount;
an administrative reimbursement amount; and
calculating, by the report generating tool, a reimbursement total comprising at least the payroll reimbursement amount, the equipment reimbursement amount, and the one or more other reimbursement amounts;
wherein the generated report comprises the reimbursement total.

13. The method of claim 9, further comprising:
in response to querying the one or more databases for invoices corresponding to search criteria comprising one or more of a date between the start date and end date or the name for the user selected type of report, retrieving, by the report generating tool, a plurality of invoices corresponding to the search criteria;
receiving, by the report generating tool, an identification of one or more of the plurality of invoices, wherein the one or more invoices are identified based on user input and the identified invoices are included in the generated report.

14. The method of claim 13, further comprising:
in response to identifying one or more of a total invoice amount, an invoice number, or an invoice date on at least one of the identified invoices, automatically populating, by the report generating tool, one or more fields of a contract labor tab, a materials tab, a rentals tab, or an equipment tab with one or more of the total invoice amount, the invoice number; or the invoice date, wherein one or more of the total invoice amount, the invoice number, or the invoice date are identified based on contents of each identified invoice.

15. The method of claim 9, wherein the government agency is one or more of the set comprising:
Federal Emergency Management Agency (FEMA); and
United States Department of Agriculture (USDA).

16. The method of claim 9, further comprising:
numbering each page of the generated report; and
adding an index page to the generated report.

17. One or more computer-readable non-transitory storage media in one or more computing systems, the media embodying logic that is operable when executed to:
receive, based on user selection, an identification of a type of report to be generated;
receive, based on user selection, an identification of a start date and an end date for the user selected type of report to be generated, the start date and the end date defining a duration for the user selected type of report;
retrieve, from the one or more databases, a first portion of payroll data comprising one or more pay rates for each of one or more employees and a plurality of time entries, each time entry corresponding to a particular employee and occurring between the start date and the end date, each time entry comprising at least a start time and an end time;
in response to a user selection of one or more of the plurality of time entries, identify a second portion of payroll data corresponding to the user selected type of report, the second portion of payroll data being either the same as, or a subset of, the first portion of payroll data;
determine a payroll reimbursement amount calculated based on the second portion of payroll data and a first reimbursement percentage; and
generate a report comprising the payroll reimbursement amount, wherein the report is submitted to one or more of a government agency for reimbursement of expenses related to a rebuild or repair of at least one structure.

18. The media of claim 17, wherein the logic is further operable to:
determine, based on user input, a cost code corresponding to an equipment used between the start date and the end date;
identify, based on user input, one or more of the selected time entries as being associated with the equipment;
determine, based on the identified time entries, a number of hours that the equipment was operated; and
calculate an equipment reimbursement amount based on the cost code, the number of hours that the equipment was operated, and a second reimbursement percentage;
wherein the report further comprises the equipment reimbursement amount.

19. The media of claim 17, wherein the logic is further operable to:
calculate one or more other reimbursements amounts based on user input and one or more reimbursement percentages, the one or more reimbursement amounts being one or more of:
a materials reimbursement amount;
a rental reimbursement amount;
a contract labor reimbursement amount; and
an administrative reimbursement amount; and
calculate a reimbursement total comprising at least the payroll reimbursement amount, the equipment reimbursement amount, and the one or more other reimbursement amounts;
wherein the generated report comprises the reimbursement total.

20. The media of claim 17, wherein the logic is further operable to:
retrieve, in response to querying the one or more databases for invoices corresponding to search criteria comprising one or more of a date between the start date and end date or a name for the user selected type of report, a plurality of invoices corresponding to the search criteria; and
receive, based on user input, an identification of one or more of the plurality of invoices, wherein the identified invoices are included in the generated report.
